(19) United States
(12) Patent Application Publication
(10) Pub. No.: US 2008/0065917 A1
(43) Pub. Date: Mar. 13, 2008

(54) Information Processing Apparatus and Resume Control Method

(76) Inventor: Hajime Suzukawa, Hino-shi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/841,370

(22) Filed: Aug. 20, 2007

(30) Foreign Application Priority Data
Sep. 13, 2006 (JP) 2006-248378

(51) Int. Cl. G06F 1/32

(52) U.S. Cl. 713/323

(57) ABSTRACT

According to one embodiment, an information processing apparatus is enabled to change a state from an operating state to a standby state, a hibernation state and a power-off state, and resume from the standby state, the hibernation state, and the power-off state to the operation state. The information processing apparatus includes a device that receives input information instructing to perform the resume process, a first controller connected to the device and a second controller connected to the first controller. The resume process is performed through the first controller and the second controller in response to the input information received by the device in the hibernation state and the power-off state, and performed through the first controller and the second controller in response to the input information received by the device in the standby state.

### CROSS-REFERENCE TO RELATED APPLICATIONS

This application is based upon and claims the benefit of priority from Japanese Patent Application No. 2006-248378, filed Sep. 13, 2006, the entire contents of which are incorporated herein by reference.

### BACKGROUND

1. Field

An aspect of the present invention relates to an information processing apparatus capable of resuming from a sleep state and a power-off state, and to a resume control method therefor.

2. Description of the Related Art

Usually, information process apparatuses, such as a personal computer, can reduce power consumption by changing a working state from an operating state to a sleep state. Especially, battery-powered portable information processing apparatuses, such as a notebook computer, can increase a driving time. Examples of this sleep state are a standby state (or suspend state) and a hibernation state.

In the case of some kind of the sleep state, it is necessary to supply electric power to a part of components of external devices, instead of completely shutting off the power supply for a personal computer. By way of example, some USB device needs supplying electric power even when a personal computer is in a sleep state. For example, in a case where a personal computer having been in a sleep state is returned to an operating state by operating an external keyboard serving as a USB device, even when the personal computer is in a sleep state, it is necessary to supply electric power to the external keyboard.

JP-A-2003-44177 discloses an electric power management method enabled to perform electric power supply according to the state of a power supply for a computer apparatus. Usually, in a computer apparatus, such as a personal computer, a power supply for an external extended device is controlled under the control of an operating system (OS). However, according to a power supply management method disclosed in JP-A-2003-44177, the external extended devices are made to function, without causing the OS to operate during a hibernation state, by controlling the power supply to the external extended device while the computer apparatus is in a hibernation state. For example, in a case where the computer apparatus is in an on-mode, the power supply is controlled by the OS and a BIOS. In cases where the computer apparatus is in a sleep mode, and where the computer is in an off-mode, the power supply is controlled by an embedded controller.

Meanwhile, in a case where the use of an information processing apparatus having been in a sleep state is resumed, it is necessary to return the information processing apparatus to an operating state. However, there has been a device that can resume from only a predetermined sleep state, due to the limitation of the design and the specification thereof. For example, the USB devices can resume from a standby state. However, the USB devices cannot resume from a hibernation state and a power-off state.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram illustrating a system configuration of an information processing apparatus according to an embodiment of the invention;

FIG. 2 is an exemplary state transition diagram illustrating changes in state of the information processing apparatus shown in FIG. 1;

FIG. 3 is an exemplary flowchart illustrating a process of changing a state S0 of the image processing apparatus shown in FIG. 1 to states S3, S4, and S5;

FIG. 4 is an exemplary flowchart illustrating a resume control method for the information processing apparatus shown in FIG. 1;

FIG. 5 is an exemplary flowchart illustrating the resume control method in a case where the information processing apparatus shown in FIG. 1 has only one IR receiver controller;

FIG. 6 is an exemplary flowchart illustrating a method of switching between two kinds of resume processes according to the configuration of the information processing apparatus shown in FIG. 1;

FIG. 7 is an exemplary block diagram illustrating a system configuration of an information processing apparatus according to another embodiment of the invention;

FIG. 8 is an exemplary block diagram illustrating a system configuration of an information processing apparatus according to another embodiment of the invention; and

FIG. 9 is an exemplary block diagram illustrating a system configuration of an information processing apparatus according to another embodiment of the invention.

### DETAILED DESCRIPTION

Various embodiments according to the invention will be described hereinafter with reference to the accompanying drawings. In general, according to one embodiment of the invention, an information processing apparatus is enabled to change a state from an operating state to a standby state, a hibernation state and a power-off state, and resume from the standby state, the hibernation state, and the power-off state to the operation state by performing a resume process of booting an operating system. The information processing apparatus includes a device, a first controller and a second controller. The device receives input information instructing to perform the resume process. The first controller is connected to the device, and supplied with electric power in the standby state, the hibernation state and the power-off state. The second controller is connected to the first controller, and supplied with electric power in the standby state. The resume process is performed through the first controller and the second controller in response to the input information received by the device in the hibernation state and the power-off state. The resume process is performed through the first controller and the second controller in response to the input information received by the device in the standby state.

Hereinafter, embodiments of the invention are described with reference to the accompanying drawings.

First, an information processing apparatus 100 according to an embodiment of the invention is described below.

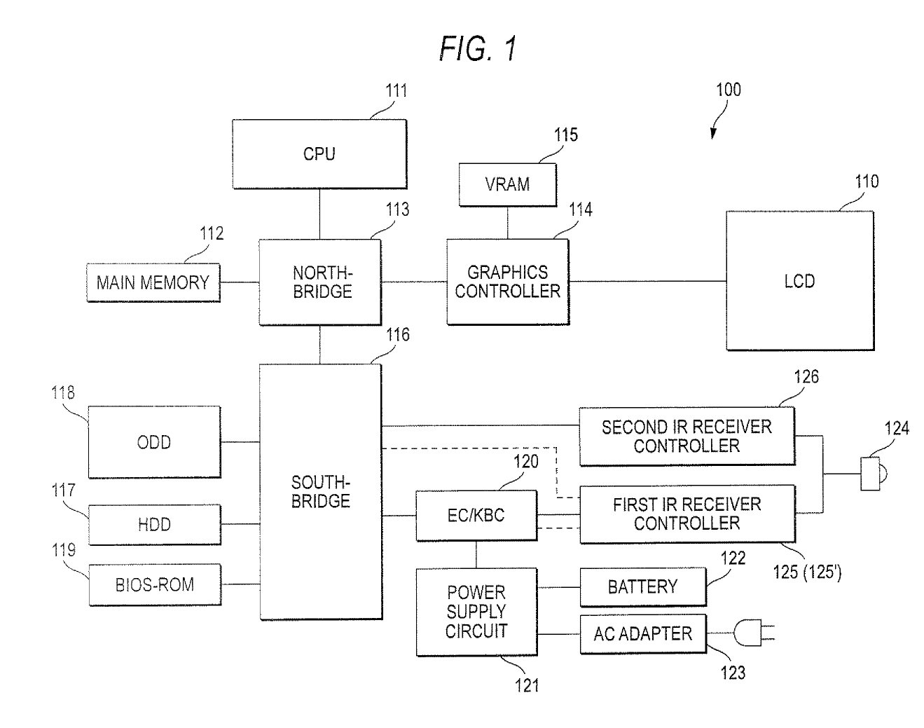

FIG. 1 is a block diagram illustrating a system configuration of the information processing apparatus 100. The information processing apparatus 100 is, for example, a personal computer or a notebook personal computer. As shown in FIG. 1, the information processing apparatus 100 includes a liquid crystal display (LCD) 110, a CPU 111, a main memory 113, a graphics controller 114, a video memory (VRAM) 115, a southbridge 116, a hard disk drive (HDD) 117, an optical disk drive (ODD) 118, a BIOS-ROM 119, an embedded controller/keyboard controller IC (EC/KBC) 120, a power supply circuit 121, a battery 122, an AC adapter 123, a light receiving portion 124, a first infrared (IR) receiver controller 125, and a USB device (a second infrared ray (IR) receiver controller) 126.

The CPU 111 is a processor that controls an operation of the information processing apparatus 100. The CPU 111 executes an operating system (OS) and various application programs loaded from the hard disk drive (HDD) 117 into the main memory 112. Also, the CPU 111 executes BIOS (Basic Input/Output System) stored in the BIOS-ROM 119. The BIOS is a program adapted to control hardware.

The northbridge 113 is a bridge device connecting between a local bus, which is connected to the CPU 111, and the southbridge 116. The northbridge 113 has a memory controller configured to control an access to the main memory 112. Also, the northbridge 113 has the function of performing communication with the graphics controller 114 through an AGP (Accelerated Graphics Port) bus.

The graphics controller 114 is a display controller configured to control the LCD 110 to be used as a display monitor of the information processing apparatus 100. The graphics controller 114 outputs a video signal corresponding to display data written to the VRAM 115 by the DS or the application program.

The southbridge 116 controls each device on a LPC (Low Pin Count) bus, and each device on a PCI (Peripheral Component Interconnect) bus. Also, the southbridge 116 incorporates an IDE (Integrated Drive Electronics) controller used to control the HDD 117 and the ODD 118. The southbridge 116 is referred to also as an I/O controller hub (ICH).

The HDD 117 is a storage device that stores various software and data. The optical disk drive (ODD) 118 is a drive unit that drives DVD media, which store video contents such as DVD titles, and CD media which store music data.

The embedded controller/keyboard controller IC (EC/KBC) 120 is a one-chip microcomputer in which an embedded controller that manages electric-power and a keyboard controller that controls a keyboard (not shown) and a touch pad (not shown) are integrated. The EC/KBC 120 is always turned on by electric power supplied from the power supply circuit 121, regardless of whether the power supply for the information processing apparatus 100 is turned on. The EC/KBC 120 performs a process of turning on/off the power supply for the information processing apparatus 100, in cooperation with the power supply circuit 121, in response to an operation performed by a user on a power button (not shown).

The power supply circuit 121 generates electric power by using of electric power supplied from the battery 122 incorporated in the information processing apparatus 100 or from an external device through the AC adapter 123, and supplies the generated electric power to each component of the information processing apparatus 100.

The light receiving portion 124 receives an infrared signal transmitted from a remote controller (not shown) to the information processing apparatus 100. The received infrared signal is supplied to the first IR receiver controller 125 and the second IR receiver controller 126.

The first IR receiver controller 125 is connected to the EC/KBC 120 and is always turned on. The EC/KBC 120 can determine the state of the information processing apparatus 100 between the standby state, the hibernation state, and the power-off state. The first IR receiver controller 125 extracts a remote control code from an infrared signal supplied from the light receiving portion 124.

The second IR receiver controller 126 is connected to the southbridge 116. Incidentally, FIG. 1 shows the second IR receiver controller 126 as an example of the USB device. In a case where the information processing apparatus 100 is in the hibernation state or the power-off state, the second IR receiver controller 126 is turned off. The second IR receiver controller 126 extracts a remote control code from an infrared signal supplied from the light receiving portion 124.

In a case where the information processing apparatus 100 has two IR receiver controllers 125 and 126, as shown in FIG. 1, different functions can be assigned to the two IR receiver controllers, respectively. For example, in a case where the information processing apparatus 100 supports two operating systems, the information processing apparatus 100 may be adapted so that one of the IR receiver controllers supports functions relating to a first operating system, while the other IR receiver controller supports functions relating to a second operating system. In a case where the information processing apparatus 100 has a function of a television receiver, the information processing apparatus 100 may be adapted so that one of the IR receiver controllers supports functions relating to the television, while the other IR receiver controller supports functions relating to the operating system.

Incidentally, the information processing apparatus 100 can be configured to have only a first IR receiver controller 125′ directly connected to both the EC/KBC 120 and the southbridge, without having the second IR receiver controller 126. FIG. 1 illustrates the connection relation among the first IR receiver controller 125′, the southbridge 116, and the EC/KBC 120 by dashed lines.

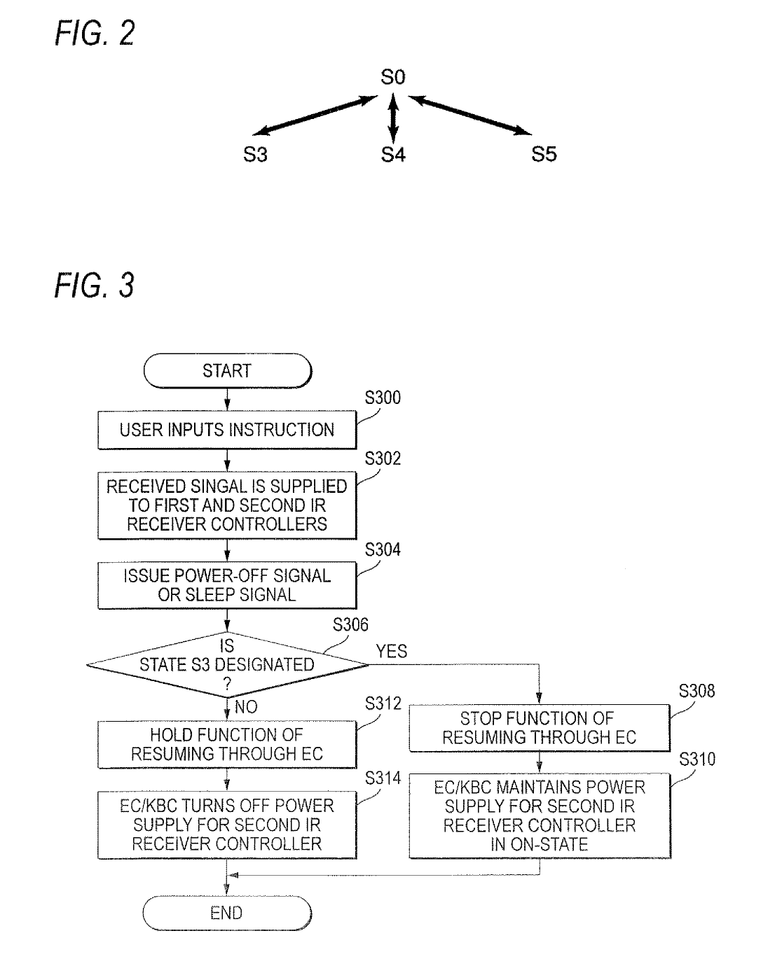

Hereinafter, various power states of the information processing apparatus 100 are described below with reference to FIG. 2.

FIG. 2 is a schematic diagram illustrating a part of the power states defined according to ACPI (Advanced Configuration and Power Interface) standards. In FIG. 2, reference character “S0” denotes an OS startup state (or power-on state). Reference character “S3” denotes a standby state (or suspend state). The standby state is a state in which information representing the state of the information processing apparatus 100 just before the turning-off of the power is stored in the main memory 112, and in which when the information processing apparatus 100 is restarted, an operation can be resumed in an immediately preceding state. In the state S3, both the first IR receiver controller 125 and the second IR receiver controller 126 shown in FIG. 1 are turned on. Reference character “S4” denotes a hibernation state. The hibernation state is a state in which information representing the state of the information processing apparatus 100 just before the turning-off of the power is stored in the HDD 117, and in which when the information processing apparatus 100 is restarted, an operation can be resumed in an immediately preceding state. Reference character “S5” denotes a power-off state. The power-off state is a state in which the power supply for the information processing apparatus 100 is turned off. In the states S4 and S5, the first IR receiver controller 125 is turned on, while the second IR receiver controller 126 is turned off. In addition to the states S3, S4 and S5, the states S1 and S2 are defined. However, in the present specification, the description of the definitions of the states S1 and S2 is omitted.

As indicated by arrows shown in FIG. 2, the state S0 of the information processing apparatus 100 can be changed to the state S3, S4, or S5. Conversely, the state S3, S4, or S5 of the information processing apparatus 100 can be changed to the state S0 (i.e., the information processing apparatus 100 can perform a resume process of resuming the state S0 from the state S3, S4, or S5).

Next, a transition process of changing the power-on state S0 of the information processing apparatus 100 to the state S3, S4, or S5 is described below with reference to FIG. 3.

FIG. 3 is a flowchart illustrating the transition process of changing the power-on state S0 of the information processing apparatus 100 to the state S3, S4, or S5. In a case where when the power supply for the information processing apparatus 100 is on, a user operates a remote controller (not shown) to instruct to change the power-on state of the information processing apparatus 100 to the state S3, S4, or S5, a predetermined infrared signal is transmitted from the remote controller in step S300. The transmitted infrared signal is received by the light receiving portion 124 of the information processing apparatus 100 and is then supplied to the first IR receiver controller 125 and the second IR receiver controller 126 in step S302. In this case, a predetermined signal is supplied to the OS through the EC/KBC 120 from the first IR receiver controller 125. Then, the OS issues a predetermined signal (e.g., a sleep signal and a power-off signal) according to the instruction from the user in step S304. The information processing apparatus 100 can be configured so that the OS issues a sleep signal, for example, in a case where there is no input information to the information processing apparatus 100 over a predetermined time period in a state in which the power supply for the information processing apparatus 100 is on. It is determined in step S306 whether the issued signal designates the state S3 (i.e., the standby state).

In a case where the issued signal designates the state S3 (YES in step S306), the function (i.e., the resume function) of performing a resume process through the EC/KBC 120 is stopped in step S308. Also, in step S310, the EC/KBC 120 maintains the second IR receiver controller 126 to be turned on. That is, the second IR receiver controller 126 gets involved in the resume process performed by the information processing apparatus 100.

In a case where the issued signal does not designate the state S3 (NO in step S306), that is, in a case where the issued signal designates the state S4 or S5, the resume function to be performed through the EC/KBC 120 is held in step S312. Also, in step S314, the EC/KBC 120 turns off the second IR receiver controller 126 in step S314. That is, the second IR receiver controller 126 does not get involved in the resume process performed by the information processing apparatus 100.

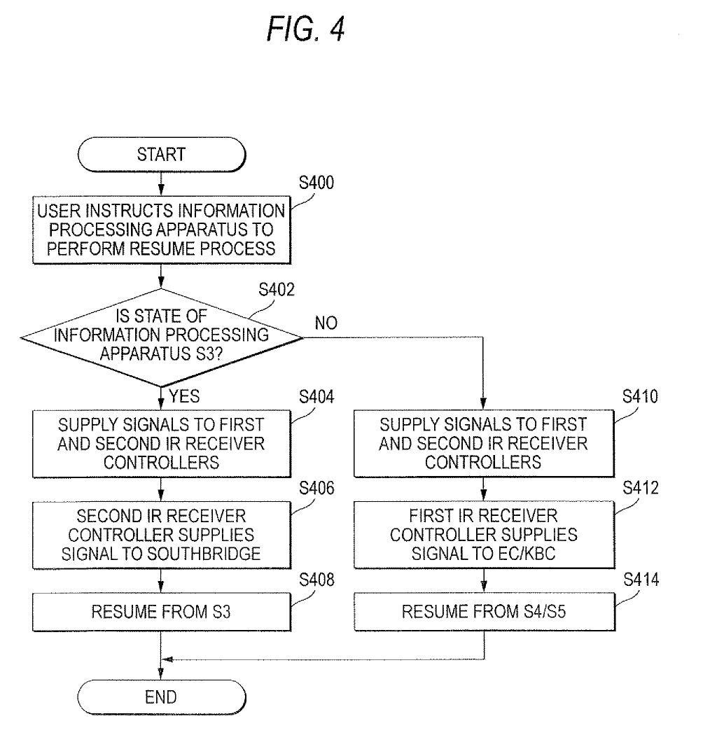

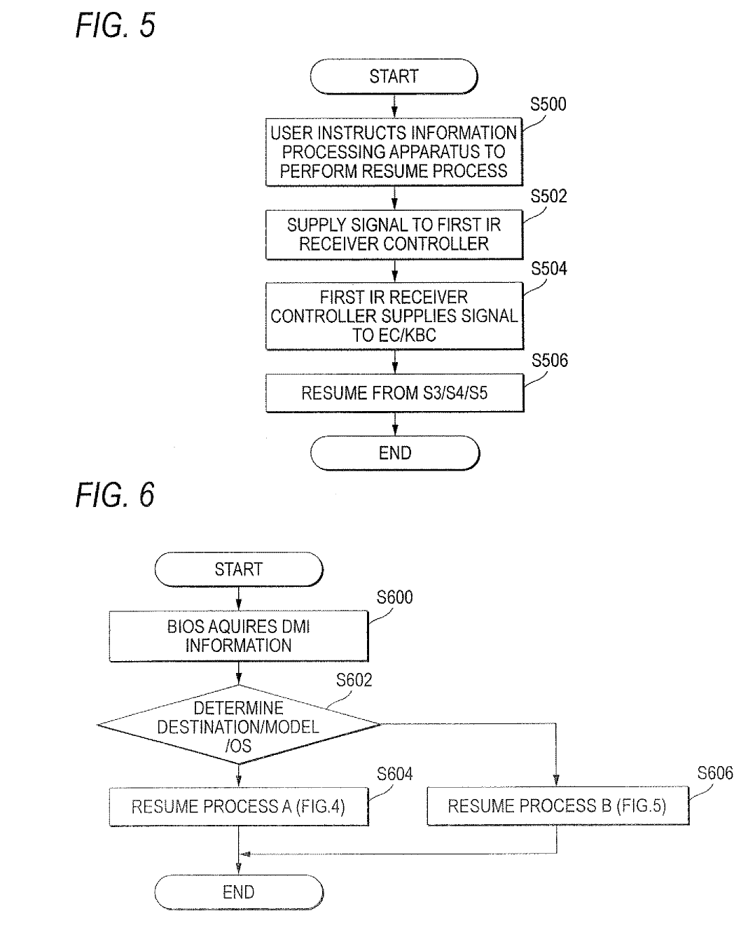

Next, a resume process of resuming the state S0 from the state S3, S4, or S5 of the information processing apparatus 100 is described below with reference to FIG. 4.

FIG. 4 is a flowchart illustrating a resume control method according to an embodiment of the invention. This resume control method can be applied to, for example, the information processing apparatus 100 shown in FIG. 1. Hereinafter, a case, in which the resume control method according to the present embodiment is applied to the information processing apparatus 100, is described by way of example.

When a user operates the remote controller to instruct the information processing apparatus 100 to perform a resume process, the remote controller transmits a predetermined infrared signal in step S400. The resume process performed by the information processing apparatus 100 is branched in step S402 to different resume processes respectively corresponding to a case where the information processing apparatus 100 is in the state S3, and another case where the information processing apparatus 100 is in the state S4 or S5.

In a case where the information processing apparatus 100 is in the state S3 (YES in step S402), the transmitted infrared signal is received by the light receiving portion 124 of the information processing apparatus 100. The received signal is supplied from the light receiving portion 124 to the first IR receiver controller 125 and the second IR receiver controller 126 in step S404. The fist IR receiver controller 125 outputs a remote control code, which is extracted from the infrared signal, to the EC/KBC 120. However, in this case, the EC/KBC 120 does not output a wakeup signal. On the other hand, the second IR receiver controller 126 supplies a USB wakeup signal to the southbridge 116 in step S406. In response to this USB wakeup signal, the information processing apparatus 100 performs a resume process of resuming from the state S3 in step S408. More specifically, when receiving the wakeup signal or the USB wakeup signal, the southbridge 116 boots the OS which performs the resume process of resuming from the state 33. Incidentally, in a case where the information processing apparatus 100 has only one IR receiver controller, that is, the first IR receiver controller 125′, a wakeup signal is supplied from the first IR receiver controller 125′ to the southbridge 116 in step S406.

In a case where the information processing apparatus 100 is in the state 34 (NO in step S402), the transmitted infrared signal is received by the light receiving portion 124 of the information processing apparatus 100. The received signal is supplied from the light receiving portion 124 to the first IR receiver controller 125 and the second IR receiver controller 126 in step S410. The first IR receiver controller 125 supplies a remote control code, which is extracted from the infrared signal, to the EC/KBC 120 in step S412. The EC/KBC 120 confirms that the state of the information processing apparatus 100 is S4. Then, the EC/KBC 120 outputs a wakeup signal to the southbridge 116. When receiving the wakeup signal, the southbridge 116 boots the OS. Then, the OS performs the resume process of resuming from the state S4 in step S414. On the other hand, the second IR receiver controller 126 is turned off in the case where the information processing apparatus 100 is in the state S4. Thus, the second IR receiver controller 126 does not output a USB wakeup signal. Incidentally, in the case where the information processing apparatus 100 has only one IR receiver controller, that is, the first IR receiver controller 125′, the received signal is supplied to the first IR receiver controller 125′ in step S410. Subsequently, the process to be performed in steps S412 and S414 is similar to the foregoing process.

In a case where when the information processing apparatus 100 is in the state S5 (NO in step S402), a user operates the remote controller to instruct to resume, a resume process similar to the above resume process of resuming from the state S4 is performed. Hereinafter, the resume process having been described with reference to FIG. 4 is referred to as a “resume process A”.

The embodiment described in the foregoing description can implement a resume control method for the information processing apparatus, which enables resuming from more various power states.

Incidentally, according to the above embodiment, the information processing apparatus 100 has two IR receiver controllers, that is, the first IR receiver controller 125 and the second IR receiver controller 126. However, the information processing apparatus 100 can be configured to have only one IR receiver controller, that is, the first IR receiver controller 125. In this case, all the resume processes of resuming from the states S3, of resuming from the state S4, and of resuming from the state S5 are performed by the EC/KBC 120 through the first IR receiver controller 125.

A resume process in the case, in which the information processing apparatus 100 has only the first IR receiver controller 125, is described below with reference to FIG. 5.

FIG. 5 is a flowchart illustrating the resume process in the case where the information processing apparatus 100 has only the first IR receiver controller 125. When a user operates the remote controller to instruct the information processing apparatus 100 to perform the resume process of resuming from the state S3, S4, or S5, a predetermined infrared signal is transmitted from the remote controller in step S500. The transmitted infrared signal is received by the light receiving portion 124 of the information processing apparatus 100. Then, the received signal is supplied from the light receiving portion 124 to the first IR receiver controller 125 in step S502. The first IR receiver controller 125 outputs a predetermined signal to the EC/KBC 120 in step S504. Then, in step S506, the resume process of resuming from the state S3, S4, or S5 is performed. Hereinafter, the resume process illustrated in FIG. 5 is referred to as a “resume process B”.

Additionally, the two kinds of the resume processes (i.e., the resume process A and the resume process B) can be switched according to whether the information processing apparatus 100 has only the first IR receiver controller 125 and to whether the information processing apparatus 100 has the first IR receiver controller 125 and the second IR receiver controller 126.

A method of switching between the two kinds of resume processes according to the configuration of the information processing apparatus 100 is described below with reference to FIG. 6.

FIG. 6 is a flowchart illustrating the method of switching between the two kinds of the resume processes according to the configuration of the information processing apparatus 100. First, the BIOS acquires DMI (Desktop Management Interface) information in step S600. For example, the destination of the information processing apparatus 100 (e.g., whether the destination is domestic or overseas) is determined by the BIOS according to the acquired DMI information in step S602. The model of the information processing apparatus 100 can be determined in step S602 in addition to the destination thereof. Also, the destination, the model, and the supported OS of the information processing apparatus 100 can be determined in step S602. Hereinafter, for simplicity of description, a case, in which only the destination of the information processing apparatus 100 is determined in step S602, is described. Additionally, it is assumed that the information processing apparatus 100 having the first IR receiver controller 125 and the second IR receiver controller 126 is of the type for overseas use, and that the information processing apparatus 100 having only the first IR receiver controller 125 is of the type for domestic use.

The resume processes are switched according to a result of the determination performed in step S602. For example, in a case where it is determined in step S602 that the information processing apparatus 100 is of the type for overseas use, that is, the information processing apparatus 100 has the fist IR receiver controller 125 and the second IR receiver controller 126, the resume process A illustrated in FIG. 4 is performed in step S604. In the case of the resume process A, the resume process of resuming from the state S3 is performed by the second IR receiver controller 126. Further, the resume process of resuming from the state S4 and that of resuming from the state S5 are performed by the first IR receiver controller 125.

On the other hand, in a case where it is determined in step S602 that the information processing apparatus 100 is of the type for domestic use, that is, the information processing apparatus 100 has only the fist IR receiver controller 125, the resume process B illustrated in FIG. 5 is performed in step S606. In the case of the resume process B, all the resume processes of resuming from the state S3, of resuming from the state S4, and of resuming from the state S5 are performed by the EC/KBC 120.

According to the above method, the two kinds of resume processes can be switched according to the configuration of the information processing apparatus 100.

Incidentally, according to the above method, the BIOS acquires the DMI information and switches between the two kinds of resume processes according to the acquired information. The DMI information may be acquired every time the information processing apparatus 100 is started. Alternatively, the DMI information may be acquired only at the first start of the information processing apparatus 100. Alternatively, the information processing apparatus 100 can be configured so that the BIOS determines whether the information processing apparatus 100 has the second IR receiver controller 126 in addition to the first IR receiver controller 125, and that the two kinds of resume processes are switched according to a result of the determination by the BIOS.

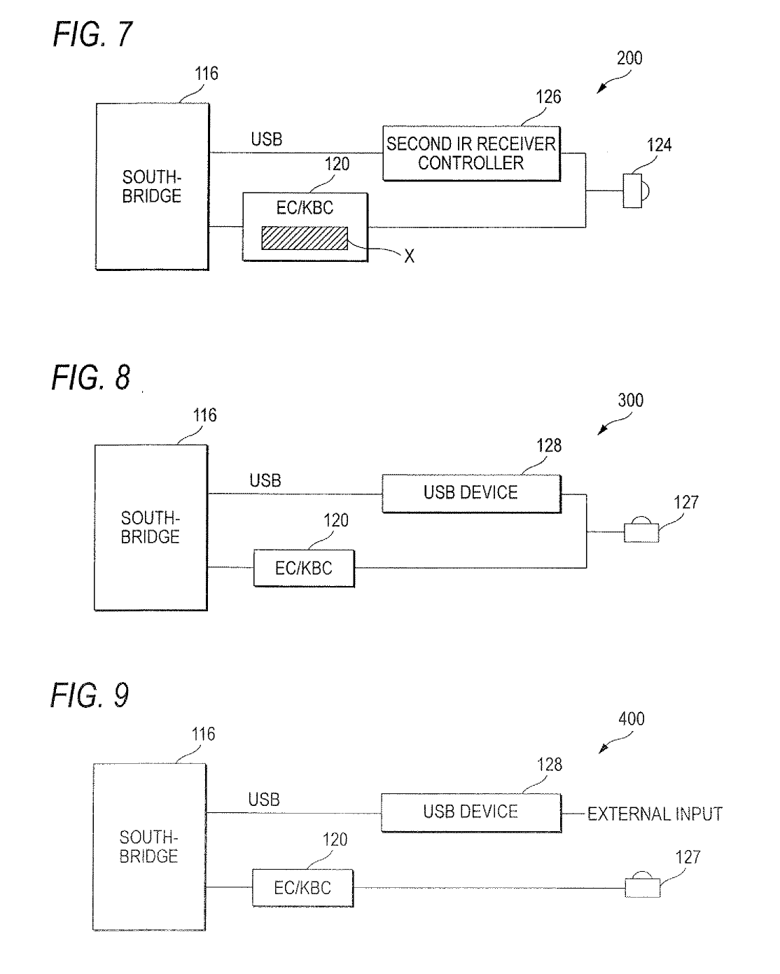

An information processing apparatus according to another embodiment of the invention is described below with reference to FIGS. 7, 8, and 9.

FIG. 7 is a block diagram illustrating a system configuration of an information processing apparatus 200 according to another embodiment of the invention. FIG. 7 illustrates only the southbridge 116, the EC/KBC 120, the light receiving portion 124, and the second IR receiver controller 126. The remaining portions of the information processing apparatus 200 are similar to the corresponding portions of the information processing apparatus 100 illustrated in FIG. 1 and are thus omitted.

In the information processing apparatus 100 illustrated in FIG. 1, the first IR receiver controller 125 is provided separately from the EC/KBC 120. However, the first IR receiver controller 125 only decodes the remote control code so that the EC/KBC 120 can recognize data obtained by decoding the remote control code. Therefore, the information processing apparatus 200 can be configured so that the EC/KBC 120 has a component that decodes the remote control code, as illustrated in FIG. 7. For example, the component that decodes the remote control code is mounted at a shaded area X of the EC/KBC 120 illustrated in FIG. 7. In this case, the second IR receiver controller 126 supplies a USB wakeup signal to the southbridge 116 and boots the OS to thereby perform the resume process of resuming from the state S3 of the information processing apparatus 200. Also, the EC/KBC 120 boots the OS through the southbridge 116 to thereby perform the resume process of resuming from the state S4 or S5 of the information processing apparatus 200.

FIG. 8 is a block diagram illustrating a system configuration of an information processing apparatus 300 according to another embodiment of the invention. FIG. 8 illustrates only the southbridge 116, the EC/KBC 120, a power supply switch 127, and a USB device 128. The remaining portions of the information processing apparatus 300 are similar to the corresponding portions of the information processing apparatus 100 illustrated in FIG. 1 and are thus omitted.

According to the embodiment illustrated in FIG. 1, the information processing apparatus 100 has one IR receiver controller (i.e., the first IR receiver controller 125′), to which a resuming instruction or a power-off instruction is input, or two IR receiver controllers (i.e., the fist IR receiver controller 125 and the second IR receiver controller 126). However, the information processing apparatus 300 can have a USB device as an instruction input portion, other than the IR receiver controllers.

In a case where the USB device 128 plays a role in an operation of turning on the power supply of the information processing apparatus 300, the resume process of resuming from the state S3 is performed through the USB device 128. The resume process in this case is similar to the process performed in steps S404, S4067 and S408 illustrated in FIG. 4. That is, the process performed by the second IR receiver controller 126 in steps S404, S406, and S408 is performed by the USB device 128. On the other hand, the resume process of resuming from the state 54 or S5 is performed through the EC/KBC 120. The resume process in this case is similar to the process performed in steps S410, S412, and S414 illustrated in FIG. 4.

FIG. 9 is a block diagram illustrating a system configuration of an information processing apparatus 400 according to still another embodiment of the invention. FIG. 9 illustrates only the southbridge 116, the EC/KBC 120, the power supply switch 127, and the USB device 128. The remaining portions of the information processing apparatus 400 are similar to the corresponding portions of the information processing apparatus 100 illustrated in FIG. 1 and are thus omitted. The USB device 128 can inform the southbridge 116 of a resuming instruction (i.e., an instruction to resume from the state S3) and of a power-off instruction according to external input information (represented by, for example, an infrared signal, a radio signal, and a set of specific key inputs from a USE keyboard). For example, the USB device 128 can be a Bluetooth® module capable of receiving a radio signal.

In the information processing apparatus 400 illustrated in FIG. 9, in a case where the USB device 128 receives an instruction (represented by the external input information) to perform the resume process of resuming from the state S3, this resume process is performed through the USB device 128. The resume process in this case is similar to the process performed in steps S404, S406, and S408 illustrated in FIG. 4. That is, the process performed by the second IR receiver controller 126 in steps S404, S406, and S408 is performed by the USB device 128. On the other hand, in a case where a user operates the power supply switch 127 to thereby issue an instruction to perform the resume process of resuming from the state S4 or S5, this resume process is performed through the EC/KBC 120. The resume process in this case is similar to the process performed in steps S410, S412, and S414 illustrated in FIG. 4.

The above embodiments can provide an information processing apparatus having a device capable of resuming from more various states of a power supply, and can provide a resume control method therefor.

Incidentally, the invention is not limited to the embodiments without modification. The invention can be implemented by modifying composite elements of embodiments without departing from the spirit and scope of the invention. For example, the first IR receiver controller 125 and the second IR receiver controller 126 can be replaced with receiver controllers configured to receive radio signals instead of infrared signals. Also, one of the receiver controllers can be USB-connected to the southbridge 116.

Additionally, the invention can be variously implemented by appropriately combining a plurality of composite elements of the embodiments with one another, which are described in the foregoing description thereof. For example, some of the composite elements can be omitted among all the composite elements of the embodiments. Additionally, the composite elements, each of which is provided in different ones of the embodiments, can be appropriately combined with one another.

What is claimed is:

1. An information processing apparatus enabled to:
change a state from an operating state to a standby state, a hibernation state and a power-off state, and
resume from the standby state, the hibernation state, and the power-off state to the operation state by performing a resume process of booting an operating system,
the information processing apparatus comprising:
a device that receives input information instructing to perform the resume process;
a first controller that is connected to the device, and supplied with electric power in the standby state, the hibernation state and the power-off state; and
a second controller that is connected to the first controller, and supplied with electric power in the standby state;
wherein the resume process is performed through the first controller and the second controller in response to the input information received by the device in the hibernation state and the power-off state; and
wherein the resume process is performed through the first controller and the second controller in response to the input information received by the device in the standby state.

2. The information processing apparatus according to claim 1, wherein the device includes a USB device.

3. The information processing apparatus according to claim 1, wherein the input information includes an infrared signal, a radio signal, or a set of specific key inputs from a USS keyboard.

4. An information processing apparatus enabled to:
change a state from an operating state to a standby state, a hibernation state and a power-off state, and
resume from the standby state, the hibernation state, and the power-off state to the operation state by performing a resume process of booting an operating system,
the information processing apparatus comprising:
a first device that receives input information instructing to perform the resume process;
a second device that receives the input information instructing to perform the resume process;
a first controller that is connected to the first device and supplied with electric power in the standby state, the hibernation state and the power-off state; and
a second controller that is connected to the first controller and the second device and supplied with electric power in the standby state;
wherein the resume process is performed through the first controller and the second controller in response to the input information received by the first device in the hibernation state and the power-off state; and
wherein the resume process is performed through the second controller in response to the input information received by the second device in the standby state.

5. The information processing apparatus according to claim 4, wherein the device includes a USB device.

6. The information processing apparatus according to claim 4, wherein the input information includes an infrared signal, a radio signal, or a set of specific key inputs from a USB keyboard.

7. A resume control method for performing a resume process of booting an operating system in an information processing apparatus, wherein the information processing apparatus is enabled to:
change a state from an operating state to a standby state, a hibernation state and a power-off state, and
resume from the standby state, the hibernation state, and the power-off state to the operation state by performing the resume process, and the information processing apparatus comprises:
a device that receives input information instructing to perform the resume process;
a first controller that is connected to the device and supplied with electric power in the standby state, the hibernation state and the power-off state; and
a second controller that is connected to the first controller and supplied with electric power in the standby state, the resume control method comprising:
receiving the input information at the device;
determining whether or not the input information instructs to perform the resume process;
performing the resume process through the first controller and the second controller in the hibernation state and the power-off state when the input information instructs to perform the resume process; and
performing the resume process through the second controller in the standby state when the input information instructs to perform the resume process.

8. The information processing apparatus according to claim 7, wherein the device includes a USB device.

9. The information processing apparatus according to claim 7, wherein the input information includes an infrared signal, a radio signal, or a set of specific key inputs from a USB keyboard.
